(19) United States
(12) Patent Application Publication
(10) Pub. No.: US 2006/0209029 A1
(43) Pub. Date: Sep. 21, 2006

(54) Operator element including freely programmable symbols

(75) Inventors: Thomas Gutbrod, Thungersheim (DE); Martin Jeitner, Ostheim (DE); Harald Schelbert, Bad Konigshofen (DE)

Correspondence Address: BIRCH STEWART KOLASCH & BIRCH, PO BOX 747, FALLS CHURCH, VA, 22040-0747, US

(73) Assignee: PREH GMBH, Bad Neustadt A.d. Saale (DE)

(21) Appl. No.: 11/373,246

(22) Filed: Mar. 13, 2006

Related U.S. Application Data
(63) Continuation of application No. PCT/EP04/09981, filed on Sep. 8, 2004.

(30) Foreign Application Priority Data
Sep. 12, 2003 (DE) DE 103 42 142.4

(51) Int. Cl. G09G 5/00

(52) U.S. Cl. 345/168

(57) ABSTRACT

An operator element having freely programmable symbols, which includes a keycap, a display unit arranged at a distance and behind the keycap in a housing of the operator element, whereby the display unit interacts with a light-guiding element so that symbols are projected onto the keycap, and a diffusion layer attached to an inner face or outer face of a top part of the keycap. Further, the display unit is self-illuminating or is a transmissive, a reflecting, or is a self-illuminating display unit that is transilluminated and/or illuminated directly by a light source or via an optical system. In addition, the keycap is made of a black-transparent material.

This nonprovisional application is a continuation application of PCT/EP2004/009981, which was filed on Sep. 8, 2004, and which claims priority to German Patent Application No. DE 103 42 142.4, which was filed in Germany on Sep. 12, 2003, and which are both herein incorporated by reference in their entirety.

### BACKGROUND OF THE INVENTION

### 1. Field of the Invention

To activate functions of various types, switches, switch panels and keyboards are used. Switches are convenient when there are only a few functions to be activated or when the functions are operated directly by a single-hand motion. For example, emergency cutoff switches or hazard warning light switches are used in motor vehicles. On the contrary, when several functions need to be operated, keypads are used. Further, keypads are becoming increasingly complex and costly. In addition, the keycaps of the switch elements are labeled with a symbol or an inscription indicating the function to be operated. A known method for labeling keycaps is disclosed in German application DE 40 18411 A1.

In addition, to prevent an increase of the number of keys for functions to be activated, multiple functions are assigned to a single key. That is, the keys are arranged around a display screen and the function symbols are displayed on the screen. Touch-sensitive display screens are also used to thereby combine the function with the symbol (see, for example, the German Publication DE 198 09 934 A1). However, in unfavorable environmental conditions, the touch-sensitive surfaces become damaged. In addition, the display screen places considerable design restrictions on the control unit or keyboard. This design restriction is particularly disadvantageous in motor vehicle applications, where the design of the interior of the vehicle should be free from restrictions.

Also known are freely programmed operator elements, which are merely labeled with numbers or unspecified symbols. However, these operator elements are disadvantageous because their function cannot be identified by their appearance. Thus, only a few operator elements are integrated and are typically allocated only once to special functions by the user and then remain permanently programmed.

In addition, another solution for displaying freely programmable symbols on an operator element is to install an LCD (liquid-crystal display) directly into a key and to cover the key with a transparent window, for example. Further, the display is firmly anchored in the keycap and moves with the key when the key is pressed. Alternatively, a stationary display may be used.

In addition, in some instances, the optical distance between the display unit and the keycap is shortened by using image guides (see, for example, the Japanese application JP-A 060044857 A or the German Application DE 100 08 670 C2). The image guides include bundles of bonded or fused oriented optical fibers, which are cut into shapes of geometric elements (for example, cuboids). In addition, the ends of the optical fibers rest on a surface of the keycap and generate an image of the surface in the focal plane. That is, the image is generated at one end the optical fiber bundle and travels through the optical fiber bundle and is displayed at the other end of the optical fiber bundle resting on the surface of the keycap.

However, even with the aid of such image guides, the image information cannot be brought directly into the keycap because an air gap must remain between the movable keycap and image guide to enable the keycap to move. This is disadvantageous because a flat keycap is used and thus the keys appear very bulky and cannot be adapted to a special design. In addition, small keys with surfaces that are barely larger than the active surface are not used, because of the required space for connections and conductive tracks on the glass. Thus, the glass surface is usually substantially larger than the active surface of the display unit. Therefore, these types of keys are primarily found in industrial applications but not inside motor vehicles, where design plays a particularly significant role.

In addition, the German application DE 198 49 973 A1 illustrates an indicator device having a controllable deflector disk, which is actuated by a control device according to the information to be displayed.

### SUMMARY OF THE INVENTION

It is therefore an object of the present invention to provide an operator element that includes modifiable symbols, thus always displaying the symbol or character (pictogram) corresponding to the functionality of the operator element.

To achieve this and other objects, the present invention generates an image of the symbol to be displayed on a display unit such as an LCD. Further, the image is then directly projected into the inside of an operator element such as into the top part of a button or into a keycap of the key. In addition, the display unit is preferably mounted inside a housing of the operator element so the size and shape of the key are not influenced by the display unit. Also, the image of the symbol is projected onto an image plane in the keycap so it becomes visible to the user. A diffusion layer in the keycap may also be mounted either on the inside or the outside of the keycap. In addition, the material of the keycap itself or any other method allowing an intermediate image to be generated in the keycap can be used as a projection plane.

Further, to provide a consistent readability of the key symbols, a widest-possible angular distribution may be provided by the distribution of the light source itself, which is used to backlight the display unit, or by a light-diffusing layer in the key. If a light-diffusing layer is used, the layer can be identical with the projection layer for the intermediate image plane, or can be realized with an additional layer or a surface scattering method.

Thus, in accordance with embodiments of the present invention, operator elements are provided with changeable symbols due to a free programmability feature for which the display unit is individually accessed. An additional indicator element can also be dispensed with because the function of the operator element is displayed on the key. At the same time, the number of operator elements can be substantially reduced because depending on the menu level, the operator elements can be set to have different functions.

Further, it is also possible to design the operator elements in accordance with a designer's specifications, especially for applications in motor vehicles. For example, the surface of the keys can be grooved or curved to match the interior design of the motor vehicle. In addition, the required size of the keycap may be determined by the maximally displayable symbol size, and not by the dimensions of the image-generating elements. Further, by selecting a black-transparent material for the key or the projection layer, a dark image can be obtained with incident light. This makes it possible to achieve a marginal optical difference between freely programmable keys and keys used in lacquer and laser technologies.

In addition, by displaying the symbols on an intermediate image plane in the key and/or a pushbutton, the image-generating plane of the display unit and the observation plane of the user are spatially separated.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a cross-sectional overview illustrating an operator element in accordance with a first embodiment of the present invention;

FIG. 2 is a cross-sectional overview illustrating an operator element in accordance with a second embodiment of the present invention; and

FIG. 3 is a cross-sectional overview illustrating an operator element in accordance with a third embodiment of the present invention.

### DETAILED DESCRIPTION

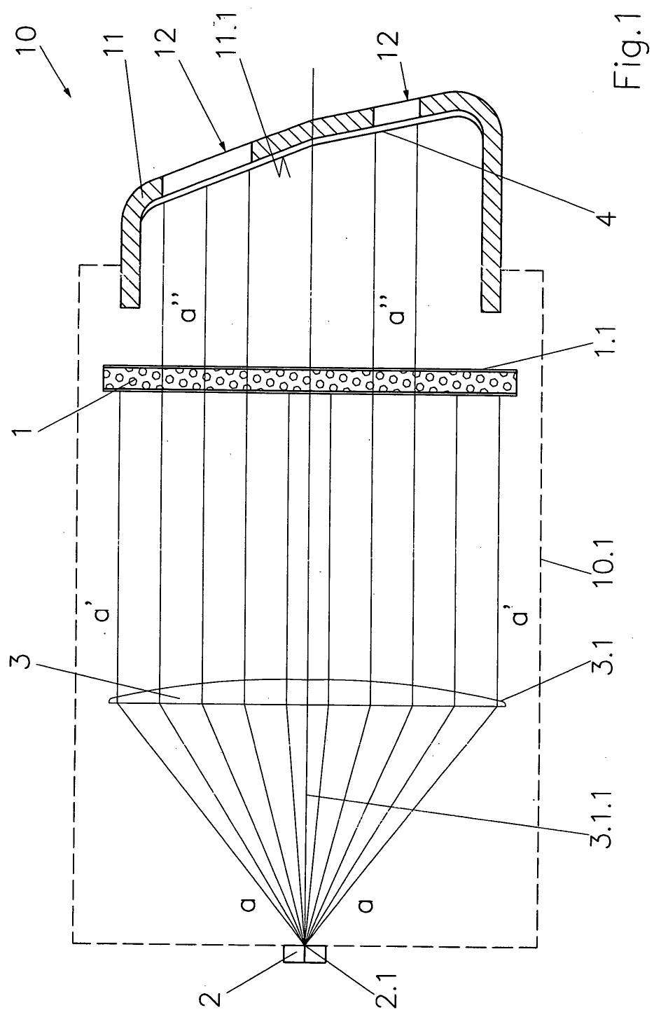

In FIGS. 1 to 3, the reference numeral 10 designates an operator element including a key having a keycap 11 into which symbols 12 are projected from the rear to make them visible to a user from the front.

Turning first to FIG. 1, which illustrates the operator element 10 including a light source 2 having an LED 2.1 for illuminating a display unit 1 integrated in a housing 10.1 (outlined only) of the operator element 10. Also included is an optical system 3 positioned in front of the light source 2.1 to thereby generate a parallel light bundle a′ from the emitted light a of the light source 2.1. That is, the optical system 3 may include a lens 3.1 at a focal point 3.1.1 of which the light source 2.1 is positioned, or may include a reflector (not shown) formed such that the light emerges in collimated bundles. Further, the lenses 3.1, reflectors, and shutters can be combined together to produce the parallel light a′. Alternatively, it is possible to integrate the optical system 3 partially or completely with the light source 2.1 such as a light source with a built-in reflector or an LED having a lens.

In addition, as shown in FIG. 1, the light source 2.1 and the optical system 3 are positioned behind the display unit 1. Also, the display unit 1 is, for example, a transmissive LCD 1.1. Thus, the display unit 1.1 functions as a transmission filter, which allows light a″ to pass through only to the area of the desired symbols 12 to be projected onto the keycap 11, and absorbs the light in other areas. Therefore, due to the parallel rear illumination, a true intermediate image can be generated by placing a diffusion layer 4 at any distance in front of the display unit 1.

In addition, because it is difficult to produce a precise parallel light bundle a′, the image resolution of the symbols 12 decreases as the distance between the display unit 1 and an intermediate image plane in the operator element 10 increases. Thus, the maximum allowable distance between the key interior 11.1 and the display unit 1 is therefore defined by the image resolution of the display unit 1, the required image resolution of the displayed symbol 12, and the remaining divergence of the light bundle a″.

In more detail, for the lens 3.1 shown in FIG. 1, the divergence of the light is derived at by simple geometric calculations from the size of the light source 2.1 and the focal range of the lens 3.1. Therefore, it is possible to reduce the divergence of the light and thus expansion of the beam between the display unit 1 and keycap 11 by using a transparent light crystal (not shown) with as high a refractive index as possible.

In addition, because the light a″ falls parallel onto the key interior 11.1, a scattering or diffusion layer 4 is provided in the keycap 11 to obtain a homogeneous light distribution of the emission on the keycap 11. Alternatively, a special foil for light deflection may be used to deflect the entire light to a small solid angle area such as a visual angle range of the driver of a motor vehicle. Further, the keycap 11 is preferable made of a black-transparent material. Thus, by selecting a black-transparent material for the keycap 11 or the projection layer, a dark image can be obtained with incident light. This makes it possible to achieve a marginal optical difference between freely programmable keys and keys used in lacquer and laser technologies.

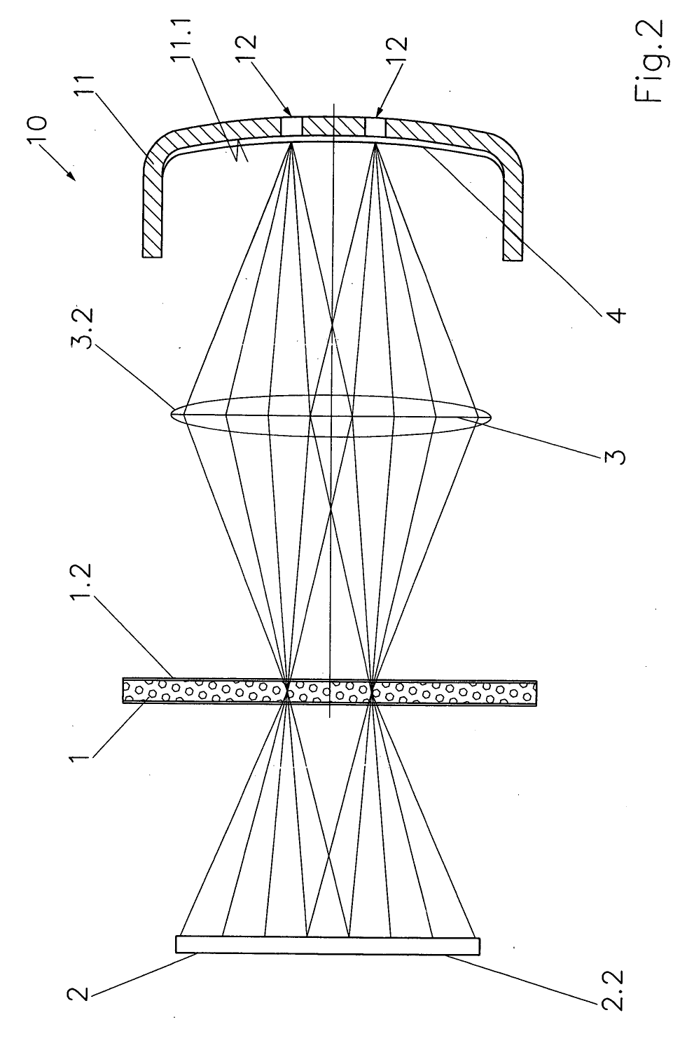

Turning next to FIG. 2, which illustrates another embodiment in accordance with the present invention. As shown in FIG. 2, a true image of the display unit 1 is projected onto the keycap 11 using an optic lens 3.2 provided between the display unit 1 and the keycap 11. Further, the distance between the real intermediate image plane in the keycap 11 and the display unit 1 is at least four times the focal range of the lens 3.2. In this embodiment, the display unit 1, the lens 3.2, and the keycap 11 are arranged such that only an image of the image plane of the display unit 1 is obtained on the diffusion layer 4 in the keycap 11.

Further, more than one lens 3.2 may be used to improve the image or to achieve higher light intensities on the keycap 11. Also, the consequential divergence of the light in the image-generating plane has no effect on the resolution of the image displayed on the keycap 11. Thus, it is possible to use a large-surface light source 2.2 or self-illuminating display units 1.2 to generate the symbol 12. However, the structure of the display unit 1 as shown in FIG. 1 can also be used to generate a reduced divergence of the light. In this instance, all of light a′ passing through the display unit 1.1 also falls on the image lens 3.2 and is focused on the intermediate image plane (diffusion layer 4) of the keycap 11.

Thus, in accordance with the embodiment shown in FIG. 2, a maximized or minimized image can be realized in the keycap 11. Therefore, it is possible to use very small high-resolution display units or larger display units with lower resolutions and to obtain the desired resolution on the keycap 11 via a minimized image. Further, because of the considerable distance between the keycap 11 and the display unit 1, the lens 3 may be positioned between keycap 11 and the display unit 1 and a reflective display unit (not shown) may be used. This allows the utilization of the special properties of reflective display units, for example, a very high contrast. Micro-mirror modules can also be used as reflective display units, whereby the switching of a pixel between an active and passive state is realized by tilting the corresponding mirror.

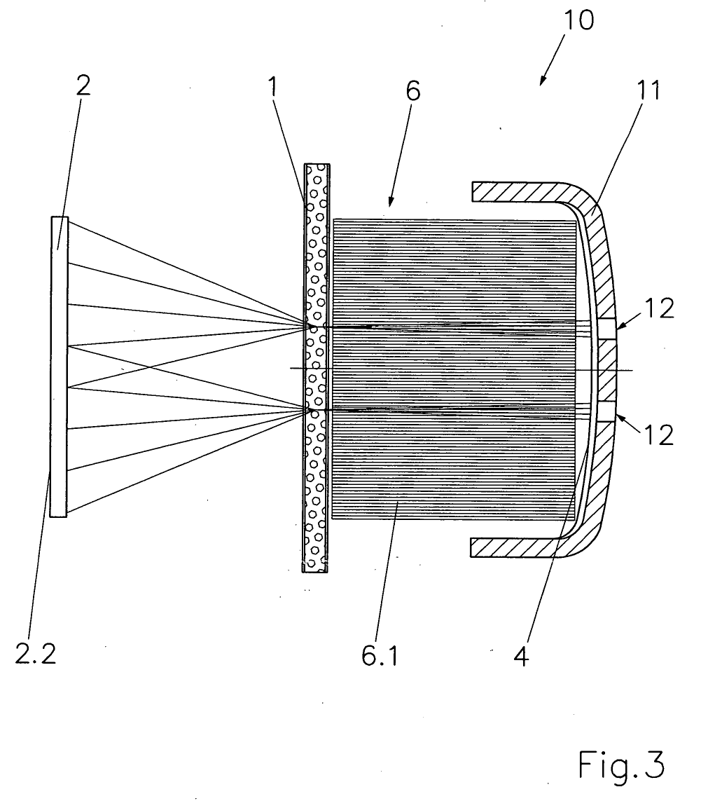

Turning next to FIG. 3, which illustrates a third embodiment in accordance with the present invention. In FIG. 3, the image from the display unit 1 is transmitted between the image-generating plane of the display unit 1 and the intermediate image plane (diffusion layer 4) using fiber-optic image guides 6. The fiber optic image guides 6 include oriented bundles of light-conduction fibers made of glass or plastic, which ensure an exact image transmission between the two ends. Further, the fiber optic image guides 6 can be in a form of independent fibers 6.1 fixedly connected together, or can be flexible bundles of fiber, whereby only the ends are affixed.

Further, a gap is provided to allow the key 10 to move up and down when the image guides 6 shown in FIG. 3 are used. For example, the image guides 6 rest on the diffusion layer 4 of the intermediate image plane or on the key interior 11.1, and are moved when the key is moved. That is, a gap is provided between the stationary image-generating plane and the moving image guides 6 to allow movement of the key 10. Alternatively, the image guides 6 can be fixedly mounted directly on the display unit 1. In this instance, the distance between the key interior 11.1 and the surface of the image guide is maintained. Due to the gap between the image guides 6 and the key interior 11.1, or between the display unit 1 and the image guides 6, a deterioration of the resolution in the intermediate image plane of the image can occur as a result of the divergence of the light. In this event, a transmissive display unit 1 backlit by preferably parallel light may be used similar to the first embodiment shown in FIG. 1.

However, it is possible not to provide a gap between the key interior 11.1, image guide 6, and display unit 1. That is, the display unit 1 can be moved in unison with the keycap 11 and the image guides 6, whereby the distance between display unit 1 and light source 2 changes such that the optical construction is not affected by the movement of the key.

In addition, if the display unit 1 is stationary, the key movement can be compensated for by using a flexible fiber bundle without providing a space between the key interior 11.1, the image guides 6 and the display unit, as long as the fiber bundles are installed such that they flex during operation of the key 10. Further, if a gap is not provided between the key interior 11.1, the image guides 6 and the display unit 1, the transmissive display unit 1.1 with a diffuser or large-surface illumination can be used, or the self-illuminating display unit 1.2 may be used.

Also, the above embodiments can also be applied to an operator element with a rotary knob, a rotary switch, a pressure switch, etc.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An operator element having freely programmable symbols, comprising:
a keycap;
a display unit arranged at a distance and behind the keycap in a housing of the operator element, whereby the display unit interacts with a light-guiding element so that symbols are projected onto the keycap; and
a diffusion layer attached to an inner face or outer face of a top part of the keycap,
wherein the display unit is self-illuminating or is a transmissive, a reflecting, or a self-illuminating display unit that is transilluminated and/or illuminated directly by a light source or via an optical system, and
wherein the keycap is made of a black-transparent material.

2. The operator element according to claim 1, wherein the light source is positioned between the display unit and the top part of the keycap.

3. The operator element according to claim 1, wherein the optical system comprises at least one optical element integrated between the light source and the display unit and/or between the display unit and the top part of the keycap.

4. The operator element according to claim 3, wherein the optical element is completely or partially integrated in the light source.

5. The operator element according to claim 1, further comprising a light crystal provided between the display unit and the top part of the keycap.

6. The operator element according to claim 1, further comprising a fiber optic image guide arranged between the display unit and the top part of the keycap.

7. The operator element according to claim 6, wherein the image guide includes oriented bundles of optical fibers made of glass or plastic in form of image rods.

8. The operator element according to claim 7, wherein the image guide is a flexible fiber bundle.

9. The operator element according to claim 1, wherein the keycap is a top part of a button.

10. A key comprising:
a keycap made of a black-transparent material and configured to be pressed by an operator;
a light source configured to emit light towards the keycap; and
a display element disposed between the light source and the keycap and configured to display an image onto the keycap, said image indicating a function to be performed when the keycap is pressed.

11. The key according to claim 10, further comprising:
an optical system configured to project light emitted by the light source onto the keycap.

12. The key according to claim 11, wherein the optical system comprises at least one optical element disposed between the light source and the display unit, said at least one optical element configured to project substantially parallel light beams onto the display element.

13. The key according to claim 11, wherein the optical system comprises at least one optical element disposed between the display unit and the keycap, said at least one optical element configured to project a true image from the display unit onto the keycap.

14. The key according to claim 12, wherein the at least one optical element is completely or partially integrated in the light source.

15. The key according to claim 10, further comprising:
a diffusion layer attached to an inner face or outer face of a top part of the keycap.

16. The key according to claim 11, further comprising:
a housing configured to house the light source, the optical system and the display element,
wherein the keycap is secured into a top part of the housing so as to be viewed by the operator.

17. The key according to claim 10, further comprising a fiber optic image guide arranged between the display unit and the keycap.

18. The key according to claim 17, wherein the image guide includes oriented bundles of optical fibers made of glass or plastic in form of image rods.

19. The key according to claim 18, wherein the image guide is a flexible fiber bundle.
